(19) United States
(12) Patent Application Publication
(10) Pub. No.: US 2023/0052344 A1
(43) Pub. Date: Feb. 16, 2023

(54) LAPTOP STAND

(71) Applicant: Ling Zhang, Zhuzhou (CN)

(72) Inventor: Ling Zhang, Zhuzhou (CN)

(21) Appl. No.: 17/402,480

(22) Filed: Aug. 13, 2021

(51) Int. Cl. A47B 23/04; F16M 11/10; G06F 1/16

(52) U.S. Cl. CPC A47B 23/043; F16M 11/10; G06F 1/166; A47B 2023/049; F16M 2200/024

(57) ABSTRACT

A multifunctional computer stand, including a symmetrically arranged push shaft, outer wall of the push shaft is movably connected with a connecting rod, and the left and right sides of push shaft are respectively connected with a first and a second rotating rod. Outer wall of connecting rod is rotatably connected with a plurality of geared fixing seats, right side of second rotating rod is provided with a plurality of limit rings, and buttons are slidably connected in limit rings. A first button and a second button are provided with a gear shaft on the lower side, a spring is fixed on the bottom surface of the gear shaft, and the other end of the spring is fixedly connected with the end surface of the connecting rod so the inner walls of the first and the second rotating rod are provided with limit teeth that mesh with the gear shaft.

### TECHNICAL FIELD

The invention mainly relates to the technical field of notebook and tablet computer accessories, in particular, to a new type of multifunctional computer stand.

### BACKGROUND

At present, with the progress of society, notebooks and tablet computers are becoming more and more popular. They can be placed on the table at will. In order to make the angle of the notebook and tablet computer adjustable, it is convenient for users to operate the keyboard and watch the display screen. The well-known computer is a tool for office, study and entertainment commonly used by modern people. Although desktop computers are the choice of most people, laptops and tablet computers are more and more popular among young people and hipsters because of their compactness and ease of carrying.

In order to solve the problem of adjusting the angle swing of the computer or the angle of the view, a computer stand is created. It can bring a certain degree of convenience, but there are still the following problems in the existing products:
1. The support height of the computer stand cannot be adjusted at will.
2. It is not possible to adjust the angle and the height of the support frame at will at the same time.
3. The level of the adjustment freedom of the support surface is not high.
4. The height and angle of the computer support frame cannot be adjusted according to personal needs or the on-site environment, which reduces the applicability to a large extent.
5. Can not quickly fix the angle and height adjustment and the other problems above-mentioned.

Therefore, the existing computer stand need further improve.

### SUMMARY

The present invention mainly provides a new type of multifunctional computer stand to solve the technical problems proposed above.

To solve the above-mentioned technical problems, the present invention adopted the technical solution: a new type of multifunctional computer support, including a symmetrically arranged push shaft, the outer wall of the push shaft is movably connected with connecting rods, and the left and right sides of the push shaft are respectively connected with each other for rotation The first rotating rod and the second rotating rod, the outer wall of the connecting rod is rotatably connected with a plurality of geared fixing seats, the right side of the second rotating rod is provided with a plurality of limit rings symmetrically up and down, the limit ring. A first button and a second button are slidably connected inside the first button and the second button. A gear shaft is provided on the lower side of the first button and the second button. A spring is fixed on the bottom surface of the gear shaft. The other end of the spring is connected to the end faces of the connecting rod are fixedly connected, and the inner walls of the first rotating rod and the second rotating rod are provided with limit teeth that mesh with the gear shaft. This design can press the first button and the second button to face the upper panel. It can be adjusted accordingly with the bottom panel and can be fixed.

Further, the upper end surface of the geared fixing seat is respectively provided with a bottom panel and a top panel, and this design can support articles.

Compared with the prior technology, the present one has the following beneficial effects.

The invention can achieve the purpose of corresponding adjustment and fixing of the bottom panel and the upper panel by arranging the gear bearing to cooperate with the gear fixed seat and the rotating rod; further, the bottom panel and the top panel are provided on the upper end surface of the gear fixed seat. The panel can support the article.

Hereinafter, the present invention will be explained in detail with reference to the drawings and specific embodiments.

### DESCRIPTION OF DRAWINGS

FIG. 1 is a schematic diagram of the overall structure of the present invention;

FIG. 2 is a schematic diagram of the open structure of the present invention;

FIG. 3 is an overall cross-sectional view of the present invention.

In the figure: 1. Pushing shaft; 2. Connecting rod; 21. Gear holder; 3. First rotating rod; 31. Limiting tooth; 4. Second rotating rod; 41. Limiting ring; 411. No. One button; 412. The second button; 5. Gear shaft; 51. Spring; 6. Bottom panel; 7. Top panel.

### DETAILED DESCRIPTION

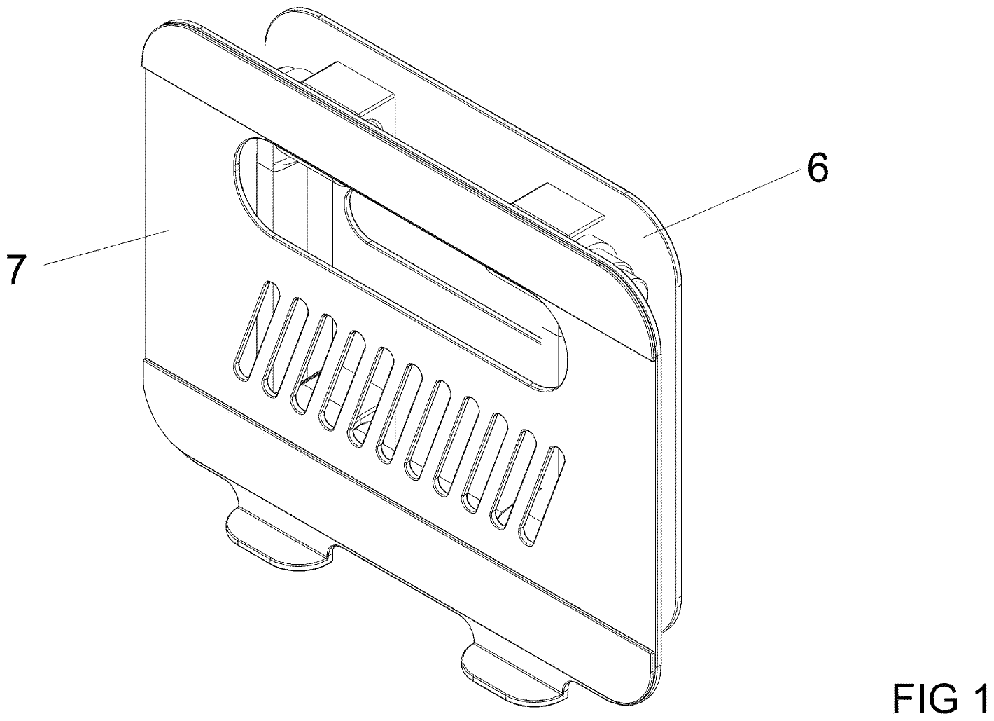

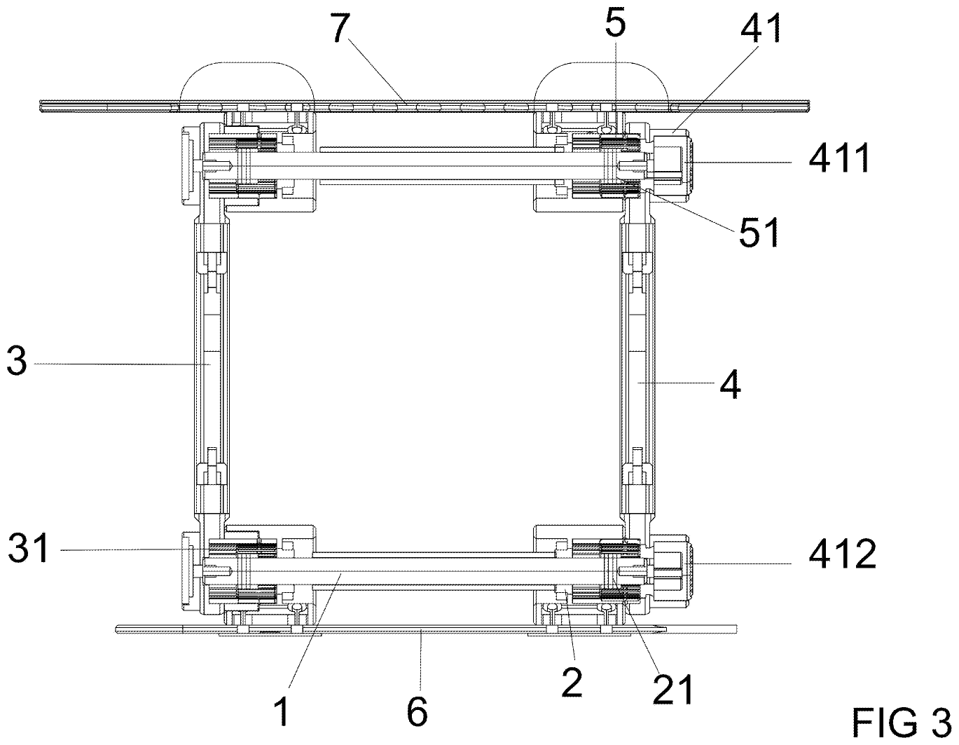

Please emphatically refer to FIGS. 1-3, a multifunctional computer stand, including a symmetrically arranged push shaft 1, the outer wall of the push shaft 1 is movably connected with a connecting rod 2, and the left and right sides of the push shaft 1 are respectively connected with a A rotating rod 3 and a second rotating rod 4, the outer wall of the connecting rod 2 is rotatably connected with a plurality of geared fixing seats 21, the right side of the second rotating rod 4 is provided with a plurality of limiting rings 41 up and down symmetrically, so A first button 411 and a second button 412 are slidably connected in the limit ring 41. The first button 411 and the second button 412 are provided with a gear shaft 5 on the lower side, and the bottom surface of the gear shaft 5 is fixed. There is a spring 51, the other end of the spring 51 is fixedly connected to the end surface of the connecting rod 2, and the inner walls of the first rotating rod 3 and the second rotating rod 4 are provided with a limit for meshing with the gear shaft 5. Position teeth 31, this design can press the first button 411 and the second button 412, adjust the bottom panel 6 and the top panel 7 accordingly and can fix them.

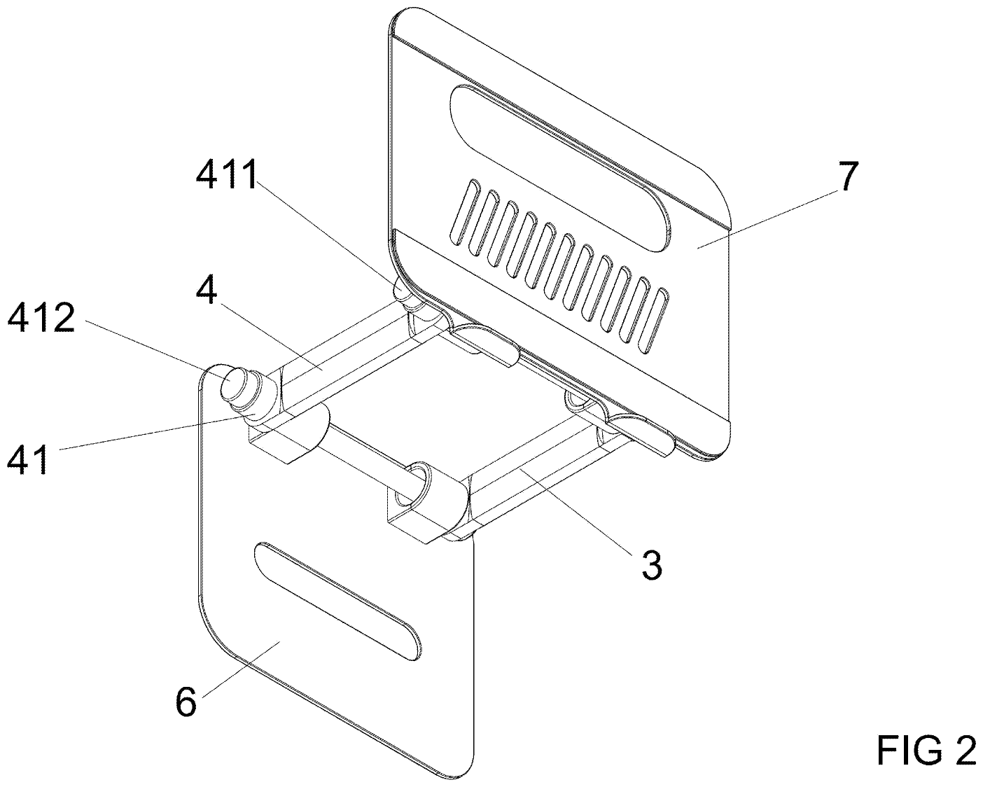

Please refer to FIGS. 1 and 2 intensively. The upper end surface of the gear holder 21 is provided with a bottom panel 6 and a top panel 7 respectively. This design can support articles.

The specific operation mode of the present invention is as follows

When using the multifunctional computer stand, place the bottom panel 6 on the desktop, press the second button 412, and the second button 412 squeezes the gear shaft 5 inward to remove it from the limit tooth 31 in the second rotating rod 4 At the same time, the gear shaft 5 squeezes the spring 51 toward the end surface of the connecting rod 2. When the gear shaft 5 is completely squeezed out of the limit teeth 31, rotate the bottom plate 6 to rotate it to the required angle, and then Place it on the desktop, loosen the second button 412, and at the same time, the spring 51 relaxes outward to drive the gear shaft 5 to relax outward. When the gear shaft 5 returns from the gear holder 21 to the limiting tooth 31 in the second rotating rod 4 When the second rotating rod 4 is fixed, and then press the first button 411, the first button 411 squeezes the other gear shaft 5 inward, and the gear shaft 5 drives the spring 51 to squeeze the end surface of the other connecting rod 2. When the gear shaft 5 is completely squeezed out of the limit teeth 31, turn the top panel 7 to adjust it to the required angle, and loosen the gear shaft 5, and at the same time, the spring 51 drives the gear shaft 5 to relax outwards. After the shaft 5 reaches the limit tooth 31, it is fixed, and the articles to be used are taken out and placed on the upper plate for use.

The present invention is exemplarily described above in conjunction with the accompanying drawings. Obviously, the specific implementation of the present invention is not limited by the above-mentioned manners. As long as the insubstantial improvement of the method concept and technical scheme of the present invention is adopted, or the concept and technical scheme of the present invention are directly applied to other occasions without improvement, they are all within the protection scope of the present invention.

I claim:

1. A multifunctional computer support, comprising:
a symmetrically arranged push shaft (1), characterized in that the outer wall of the push shaft (1) is movably connected with a connecting rod (2), and the push shaft (1) has left and right sides;
a first rotating rod (3) and a second rotating rod (4) are respectively rotatably connected to the left and right sides;
an outer wall of the connecting rod (2) is rotatably connected with a plurality of gear fixing seats (21), and the second rotating rod (4);
a plurality of limit rings (41) are symmetrically arranged on the right side of the push shaft;
a first button (411) and a second button (412) are slidably connected in a limit ring (41).;
the first button (411) and the second button (412) are provided with a gear shaft (5) on a lower side;
one end of a spring (51) is fixed on a bottom surface of the gear shaft (5);
other end of the spring (51) is fixedly connected to the end surface of the connecting rod (2);
and the inner walls of the first rotating rod (3) and the second rotating rod (4) are provided with limit teeth (31) that mesh with the gear shaft (5).

2. The multi-functional computer support according to claim 1, wherein an upper end surface of the geared fixing seat (21) is respectively provided with a bottom panel (6) and a top panel (7).
